(19) United States
(12) Patent Application Publication
(10) Pub. No.: US 2023/0055494 A1
(43) Pub. Date: Feb. 23, 2023

(54) INLINE ACOUSTIC METAMATERIAL TUNING SYSTEM

(71) Applicant: Dan Clark Audio Inc., San Diego, CA (US)

(72) Inventors: Daniel William Clark, San Diego, CA (US); Robert Jason Egger, San Diego, CA (US)

(21) Appl. No.: 17/849,432

(22) Filed: Jun. 24, 2022

Related U.S. Application Data
(60) Provisional application No. 63/234,944, filed on Aug. 19, 2021.

(51) Int. Cl. H04R 1/28; H04R 1/10

(52) U.S. Cl. CPC H04R 1/2811; H04R 1/1008; H04R 1/1058

(57) ABSTRACT

An acoustic diffusion and absorption system can have an ear coupler consisting of a transducer and an ear pad defining a volume surrounding an ear of a user. An insert may be positioned inline between the transducer and the ear of the user to fill at least a portion of the volume defined by the ear pad with the insert having a thickness and a plurality of channels. A first channel of the plurality of channels may continuously extending through the insert to form a waveguide while a second channel of the plurality of channels can have a length that is less than the thickness of the insert to form a resonator.

### RELATED APPLICATIONS

This application makes a claim of domestic priority under 35 U.S.C. 119(e) to U.S. Provisional Patent Application No. 63/234,944 filed Aug. 19, 2021, the contents of which are hereby incorporated by reference.

### SUMMARY

An acoustic metamaterial waveguide, diffusion and absorption system, in accordance with some embodiments, has an ear cup holding a transducer and an ear pad defining a volume surrounding an ear of a user. An insert may be positioned inline between the transducer and the ear of the user to fill at least a portion of the volume defined by the ear pad with the insert having a thickness and a plurality of channels. A first channel of the plurality of channels may continuously extend through the insert to form a waveguide while a second channel of the plurality of channels can have a length that is less than the thickness of the insert to form a resonator.

Other embodiments of a waveguide, diffusion, and absorption system arrange an insert with a thickness and a plurality of channels where a first channel of the plurality of channels continuously extends through the insert while a second channel of the plurality of channels terminated on one side to form a resonator.

A waveguide, diffusion and absorption system may be utilized, in various embodiments, by positioning a first insert inline between a transducer and an ear of a user in an ear coupler consisting of a baffle, ear pad, and optional cup, with the insert consisting of a first plurality of channels arranged to manage waveform propagation and to reduce an amplitude of standing waves of acoustic signals created by the transducer within the coupler. Acoustic signals are generated with the transducer and pass through the first insert with the first insert having an acoustic impedance provided by the plurality of channels to create a predetermined frequency response and acoustic damping. The first insert is then removed from the ear coupler so that a second insert can be attached into the ear coupler. The second insert has a second plurality of channels arranged to provide a different frequency response and acoustic damping than the first plurality of channels of the first insert.

### BRIEF DESCRIPTION OF THE DRAWINGS

FIG. 1 conveys a line representation of portions of an example acoustic environment in which various embodiments may be practiced.

FIG. 2 depicts a block representation of portions of an acoustic system operated in accordance with some embodiments.

FIGS. 3A & 3B respectively depict block representations of portions of example acoustic systems arranged in accordance with assorted embodiments.

FIG. 4 depicts a block representation of portions of an example acoustic diffusion and absorption system in accordance with some embodiments.

FIGS. 5A-5F respectively depict portions of an example insert that can be employed in an acoustic diffusion and absorption system.

FIG. 6 depicts a cross-sectional view of portions of example insert that can be utilized in an acoustic diffusion and absorption system.

FIGS. 7A-7D respectively depict aspects of an example insert that can be employed in an acoustic diffusion and absorption system.

FIGS. 8A-8D respectively depict portions of an example insert that can be utilized in an acoustic diffusion and absorption system.

FIGS. 9A-9D respectively depict cross-sectional aspects of example inserts that can be employed in an acoustic diffusion and absorption system.

FIGS. 10A-10D respectively depict aspects of an example insert configured in accordance with assorted embodiments.

FIGS. 11A and 11B respectively illustrate portions of an example insert arranged in accordance with some embodiments.

FIGS. 12A and 12B respectively plot operational data from an acoustic system utilized in accordance with various embodiments.

FIG. 13 depicts a line representation of portions of an example insert configured and utilized in accordance with various embodiments.

FIG. 14 depicts a perspective view of an example headphone system arranged in accordance with some embodiments.

FIGS. 15A-15D respectively depict portions of an example ear pad that can be employed in assorted embodiments.

FIGS. 16A-16D respectively illustrate portions of an example ear cup configured in accordance with some embodiments to optimize a headphone.

FIGS. 17A-17D respectively display portions of an example ear pad that can be utilized in a headphone in accordance with various embodiments.

FIG. 18 is a flowchart of an example insert utilization routine that may be carried out with assorted embodiments of FIGS. 1-17D.

### DETAILED DESCRIPTION

Embodiments are generally directed to an acoustic metamaterial waveguide, diffusion, and absorption system that optimizes transmission of acoustic waves from a transducer to an ear of a user.

In systems that generate acoustic waves designated for a single user, such as open or closed back headphones and earphones that rest on or surround an ear, the transducer, ear, and ear coupler create a complex closed system that forms standing waves which can distort, alter, and/or degrade the accuracy of the acoustic waves that increase listener fatigue and decrease system fidelity.

As is understood by members of the trade, a loudspeaker in a room will setup standing pressure waves, which are particularly problematic at low frequencies and are very difficult to correct. In headphones, the ear-hole of an ear pad, along with the listener's ear and the audio transducer, define the “room,” which is also affected by standing waves, but due to the small volume, the standing waves mostly occur above 3 KHz. Hence, there is a continuing goal to provide an acoustic system that provides physical comfort to a user while providing accurate and efficient transmission of acoustic waves by remediation of standing waves inherent to an enclosed acoustic space in headphones.

Some loudspeaker designs utilize a housing with a contoured, or textured, surface to reduce standing waves. An acoustic driver can be positioned on top of the structure while an ear cavity is provided by a housing to the rear of the driver. Such structure attempts resonance control in a manner that is distinct and different from the various embodiments of this disclosure due to the current embodiments creating an array of waveguides embedded within a diffusion surface positioned inline between transducer and ear where waveguides may be partially or wholly terminated to create quarter-wave or Helmholtz resonators that can be tuned to eliminate standing waves at a range of frequencies.

It is noted that some acoustic structures place acoustic metamaterials, or simple resonators, behind a transducer, such as in a loudspeaker box, inside an earcup of a headphone, or directly on the rear vent of a dynamic transducer. Such configurations contrast the structure and function of the present embodiments that place metamaterial directly inline between a transducer and the listener's ear.

Other acoustic structures may place a plurality of resonators around a driver, which contrast the current embodiments where some or all of the surface area within an ear pad cavity and most, or all, of the driver is covered. More specifically, peripheral resonators around a driver are intended to cover 7-9 KHz only, whereas various embodiments of an acoustic insert cover most, or all, of the driver as well as none, or all, of the exposed baffle area.

In various acoustic structures, resonators of variable tuning are embedded within a flat plate within a headphone housing to attempt to mitigate standing waves. The use of two acoustic drivers and the use of a crossover manage acoustic waves and can be positioned between two parallel flat plates. In contrast, current embodiments are deployed in objects with almost any surface geometry, and requires only one driver with no crossovers and place resonators directly inline between the transducer and the listener's ear. Other embodiments mitigate standing waves by embedding low frequency resonators within a plate, or an ear pad, to provide the ability to operate with all headphones that rest on, or surround, the ear. Further, current embodiments are directed to providing a waveguide that can be modified to behave as an integrated inline dual-function diffuser, waveguide and resonator.

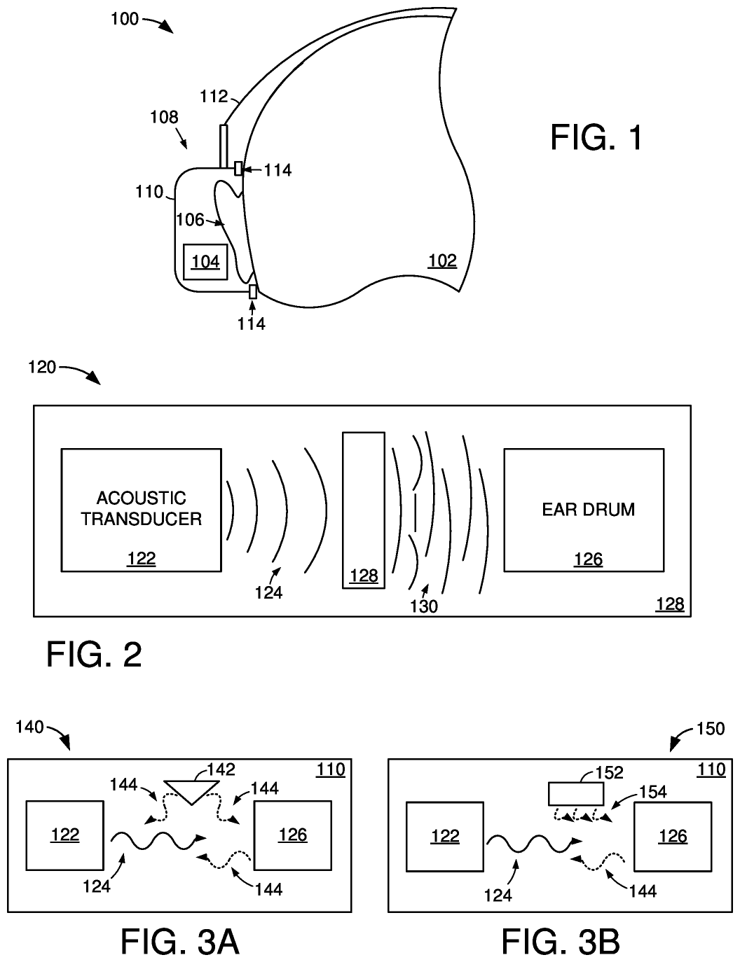

FIG. 1 depicts a line representation of portions of an example acoustic environment 100 in which assorted embodiments can be practiced. A user 102 can couple one or more acoustic drivers 104 (transducer) to an ear 106 with a headphone 108. While not limiting or required, the headphone 108 can consist of an ear coupler 110 that is enclosed or open. The ear coupler 110 is positioned adjacent an ear 106 of the user 102 by a headband 112, but such feature is not required as any head attachment means can be utilized to secure the ear coupler 110 in position relative to the user's ear 106 and head.

It is contemplated that the ear coupler 110 presents one or more ear pads 114 to physically contact the user's ear 106 and/or head. Some embodiments of the headphone 108 position some, or all, of the ear coupler 110 within the areal extent of the user's ear 106. It is noted that the areal extent of an ear can be characterized as the area within the outer boundary of a user's ear 106. For instance, an ear coupler 110 may be positioned wholly within (in-ear headphone), partially outside (on-ear headphone), or wholly outside (over-ear headphone) the areal extent of a user's ear 106.

Regardless of the position, assembly, and arrangement of the ear coupler 110 and acoustic drivers 104 relative to the ear 106, acoustic waves generated by a driver 104 can become altered, distorted, and/or degraded by standing waves before arriving at the ear drum of the user 102. That is, due to the relatively short distance, acoustic waves above 3 KHz generated by the drivers 104 can interfere to sum, or cancel, which renders the system non-linear.

FIG. 2 depicts a block representation of an example acoustic system 120 where acoustic waves are degraded in accordance with various embodiments. As shown, an acoustic transducer 122 generates an initial acoustic wave 124 directed towards a user's ear drum 126. Within the closed volume 128 defined by the components housing the transducer 122, the baffle holding the transducer, ear pad, as well as the structure of the user's ear are collectively illustrated as physical geometry and acoustic impedance 130, the initial wave 124 interacts with the acoustic structure and impedance 130 and reflects off the ear 126 creating reflected wave 132, which then sets up standing waves. It is contemplated that the reflected wave 132 then creates standing waves that degrade linearity at the ear 126, thereby creating peaks and troughs in the perceived frequency response.

The standing waves will vary in amplitude and frequency based on the individual listener's physical ear structures, ear coupler geometry, ear coupler material, and other geometric considerations. The net effect is that high frequency performance varies materially by user, as every ear is unique, and the resultant peaks and troughs create an unpredictable listening experience because the specific peaks and troughs vary in amplitude and frequency perceived by the user.

Accordingly, various embodiments are directed to structure and techniques to affect standing waves in audio with novel mechanical structure placed between the audio transducer 122 and ear drum 126 that integrates metamaterial waveguide, diffusion, and absorption techniques to reduce standing waves and smooth frequency response peaks and troughs and adjust tonal balance.

FIGS. 3A & 3B respectively depict block representations of portions of example acoustic systems 140/150 in which assorted embodiments are employed. There are two conventionally accepted approaches to mitigate standing waves in enclosed spaces; diffusion and absorption. While waveguides, resonator, and diffusion have been utilized as individual technologies in various embodiments, the integration of all three technologies within a single physical structure placed inline between the transducer and the ear provides improved product development, manufacturability, and product consistency while allowing precise control of the high-frequency performance of the system across a wide range of listener's ear's acoustic impedances that cannot be realized with standalone diffusers, absorbers, and/or resonators, particularly in headphone where space for complex apparatus is necessarily limited.

In FIG. 3A, a diffuser 142 is placed proximal to an audio transducer 122 and an ear drum 126 to randomize acoustic waves and mitigate the development of standing waves within an ear coupler, such as coupler 110 of FIG. 1. Incidental waves 144 are not limiting, but illustrate how reflected waves 146 can contribute back into other waves to reduce standing waves. However, such randomization of reflected waves can not compensate for all standing waves within a system and requires material physical space due to relevant audio wavelengths.

The acoustic system of FIG. 3B displays how placement of an acoustically absorbent material 152 proximal to the audio transducer 122 and ear drum 126 within an ear coupler 110 can reduce the amplitude of reflected waves 154 as some acoustic energy is dissipated within the absorbent material 152. The use of one or more absorbent materials 152 in a system 150 can reduce the intensity of acoustic waves reaching the ear drum 126. It is contemplated that some acoustic systems employ one or more diffusers 142 and/or absorbent materials 152 with varying shapes and/or sizes to customize the transmission and/or absorption of acoustic wave energy. Yet, user's ears are often unique and present structure that acts differently on acoustic waves and limit the benefits of conventional diffusion and absorption configurations. Hence, assorted embodiments are directed to interchangeable acoustic components that optimize and, in some embodiments, customize how acoustic waves are transferred to an ear drum 126 with respect to the structure of a user's ear.

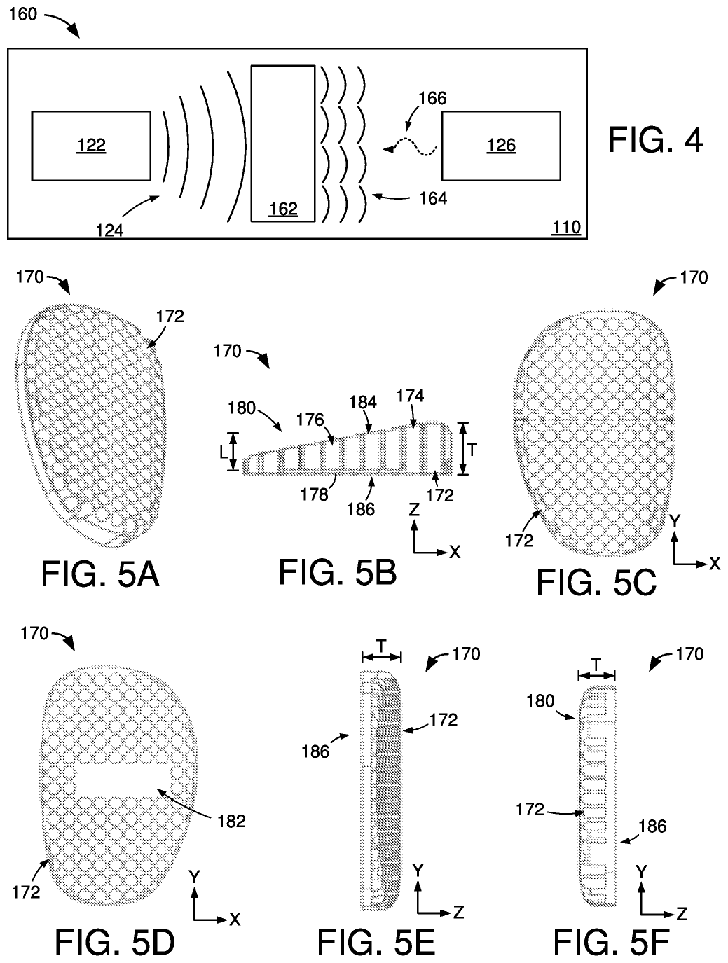

FIG. 4 depicts a block representation of portions of an example acoustic system 160 configured and operated in accordance with various embodiments to provide a waveguide with both acoustic absorption and diffusion to optimize delivery of acoustic waves to an ear drum 126. With placement of one or more inserts 162 between an audio transducer 122 and a user's ear drum 126, initial acoustic waves 124 pass through the device to become waves 164. Insert 162 is optimized to the enclosed space around the user's ear drum 126, such as the user's ear and the ear coupler housing the audio transducer 122 and insert 162. It is contemplated that the frequency response of the initial wave 164 is affected by resonators to reduce energy where standing waves are likely to form.

It is noted that pressure waves 166 reflected back from the ear drum 126, as well as the ear and ear pads, as illustrated in FIG. 1, reflect back towards the insert 162, which then diffuses portions of the wave while absorbing the reflected high frequency energy with resonators, which absorb waves at targeted frequencies prone to standing waves to insure the waves 164 are preserved as faithfully as possible between the transducer 122 and ear drum 126 in the ear coupler 110. In some embodiments, the insert 162 is configured to have partially one way flow. As such, embodiments of this disclosure are directed to an acoustic metamaterial tuning system (AMTS) that integrates a waveguide with diffusion and absorption elements into a common structure to provide a designer unprecedented control of resonances within a headphone or other acoustic wave transmission system, which results in exceptionally smooth measured acoustical frequency response.

FIGS. 5A-5F respectively depict line representations of portions of an example insert 170 that customizes and optimizes acoustic wave transmission to a user's ear, particularly in a headphone environment where the structure of a user's ear contributes to the dynamics of an enclosed volume that houses one or more acoustic transducers. By integrating diffusion and absorption into the common structure of the waveguide insert 170 between an audio transducer and a user's ear, it is possible to substantially smooth the frequency response of an acoustic system to levels heretofore unseen in headphone performance, particularly where high frequency linearity performance has been limited by the presence of standing waves.

The perspective view of FIG. 5A illustrates how the insert 170 is a single piece of material, such as a foam, polymer, metal, rubber, or combination thereof, with a plurality of separate channels 172 that respectively extend between apertures 174 in the insert 170 material, as conveyed in the cross-section of FIG. 5B. It is noted that the waveguide insert 170 may, in some embodiments, be constructed of more than one piece of material that are joined, attached, fastened, or physically adjacent when fabrication as a single component is impractical.

The cross-sectional view of FIG. 5B further shows how the insert 170 can consist of channels 172 that extend continuously through the thickness (T) of the insert 170, as measured parallel to the Z axis, along with channels 176 that are terminated on the bottom surface of the insert 170. The placement of a blocking wall 178 to close a channel 176 creates a length (L), as measured parallel to the Z axis, that forms a quarter wave resonator while surfaces of the insert 170 acts as an impedance node that reflect some of the acoustic energy through diffusion to optimize acoustic wave transmission through mitigation of standing waves on the ear-side 180 of the insert 170. The tuned position and thickness of the blocking wall 178 can control the length of the channel resonator, which provides varied acoustic performance for the plurality of channels 172/176. To clarify, the insert 170 can be configured with one or more types of channels 172/176 that continuously, or partially, extend between apertures in opposite sides of the insert 170.

The top view of the ear-side 180 of the insert 170 is conveyed in FIG. 5C and shows how the respective channels 172/176 are patterned as separate circular aspects with a common size. However, such configuration is not required or limiting as the pattern of separate channels 172/176 can consist of different sizes, shapes and separation distances. The top view of the ear side 180 of the insert 170 shown in FIG. 5D illustrates a non-limiting embodiment of the channel 172/176 pattern where a solid region 182 with no channels 172/176 is positioned approximately in the center of the insert 170, as measured in the X-Y plane. It is noted that the solid region 182 can have any size, shape, and position that can complement the apertures 174 at either end of an open channel 172 to create a larger diffusion surface area, which may or may not be contoured.

As shown in the cross-sectional profile of FIG. 5B, an ear-side 180 top surface 184 of the insert 170 can have a varying contour/topography compared to a transducer-side bottom surface 186. While not limiting, the bottom surface 186 can have a flat, non-varying contour along the Z axis while the top surface 184 has a flat, or angled, contour relative to the bottom surface 186. Tuning the slope and contour of the top surface 184 relative to the bottom surface 186 allows for varying lengths of open channels 172 and varying lengths of closed channels 176, which controls the behavior of acoustic wave transfer through the insert 170 and reduces standing waves while smoothing frequency response. It is noted that the top surface 184 forms an impedance node to diffuse wave energy striking the insert 170 and the varying surface geometry, along with the ratio of perforations to surface area and surface topography, create a tuned diffusion function for a headphone system.

FIG. 5E displays a first side profile of the insert 170 while FIG. 5F displays the opposite second side profile. The respective profiles convey how the respective channels 172/176 pattern produces different depths/lengths and each extend along the Z axis. It is noted that not all channels 172/176 are required to have a circular cross-sectional shape one or more apertures 174 and/or channels 172/176 can have a shape, size, and orientation that is tuned to optimize the acoustic wave transmission and system frequency response in response to the volume and shape of a user's ear 106 and ear drum 126. That is, the ability to tune the configuration of apertures 174 and channels 172/176 allow for precise control of how sound waves travel through, and reflect from, the insert 170.

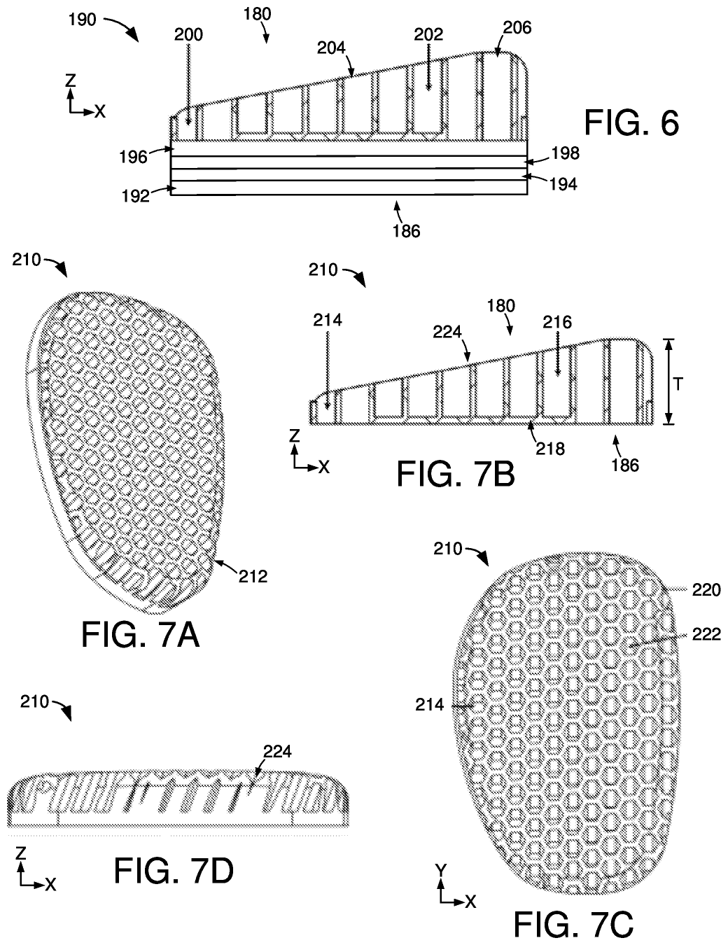

FIG. 6 depicts a cross-sectional line representation of an example insert 190 arranged in accordance with assorted embodiments to optimize the transmission of acoustic waves. An audio transducer 192, such as a planar magnetic, electret, electrostatic, or dynamic driver, outputs energy through an acoustic compression chamber 194 and plurality of material layers 196/198, before passing through a waveguide 200.

It is contemplated that the layers 196/198 can have different Rayl values to allow waves, such as wave 124 of FIG. 4, to pass through waveguide 200 to enter the cavity defined by the ear pad and the listener's ear. While some acoustic energy at targeted frequencies is absorbed by resonators 202 as waves pass through the waveguide 200, the rest of the energy enters the ear canal or reflects off the ear and ear pad back towards the insert 190. A portion of the reflected wave energy is diffused by the top surface 204 and the balance is reflected into open channels 206.

When used, the material layer 196 forms an impedance node. While not limiting, layer 196 can be a resistive material, such as an acoustic screen or paper with at least a 50 Rayl value while the porous-matrix layer 198 can be an absorbent material, such as acoustic foam or felts. The higher the Rayl value of the respective layers 196/198, the higher the Q and attenuation of the resultant resonator, which is why the solid termination of the resonators 202 results in the highest possible filter Q and attenuation.

All reflected wave energy entering the waveguide 200 passes through to the compression chamber 194 if layers 196/198 are not present, which allows standing waves to develop. Thus, configuring of one, or both, layers 196/198 with a sufficiently high Rayl value can transform channels 206 into a waveguide 200 for the initial audio wave that subsequently function as a quarter wave resonators with a low Q value to absorb reflected wave energy and greatly reduce formation of standing waves at resonator frequencies. The remaining reflected wave energy enters resonators 202 where attenuation of targeted frequencies occurs with higher Q and greater attenuation values. As such, channel 206 acts as a waveguide 200 for the initial wave, but transforms into a low Q resonator for reflected waves.

In this way, layers 196/198 transform a “two-way” waveguide 200 into a “one-way” waveguide that doubles as a low Q, low attenuation resonator for reflected wave energy. It is noted that closed resonators 202 with hard termination complement the open channels 206 and function independently of use of layers 196/198.

The waveguide 200 may have a constant, swept path, or tapered, cross-sectional area to tune how acoustic waves transfer through the insert 190. The insert 190, and constituent channels 202/206, may be oriented at any angle relative to the Z axis and audio transducer 192, and/or other waveguides, to control and direct acoustic wave propagation within the system. For example, one or more channels 202/206 can be oriented towards the pinna aspect of a user's ear while other channels 202/206 are oriented towards the concha aspect of the user's ear. It is noted that the orientation of a channel 202/206 can be defined as parallel to a longitudinal axis of the channel 202/206 between channel sidewalls.

It is noted that the insert 190 may be individually removable, affixed to the baffle or driver, or attached to impedance node 196, or attached to porous-matrix material layer 198. It is noted that the assorted channels 202/206 are not required to be parallel to one another or to the Z axis. It is contemplated that if no layer 196/198 material is in place, a reflected acoustic wave passes through the waveguide 200 then hits the transducer 192 and again reflects back through insert 190 towards the ear, creating conditions for a standing wave which, in some instances, may be desirable. Layers 196/198 maybe deployed under the entire insert 190 or under specific waveguides 200 therein to leave some channels 202/206 uncovered with material layers 196/198.

It can be appreciated that the structure of the insert 190, and specifically the contour of the top surface 208 creates an impedance node with controlled diffusion while channels 202 provide high-Q resonators for reflected waves. In accordance with some embodiments, the assorted channels 202/206 are configured as embedded resonators. An array of resonating channels 202/206, as generally illustrated in FIGS. 5A-5F, may be deployed with varying depths and/or varying Q to effect a broad-spectrum of frequency response and overlapping operating frequencies that allow the system to act as a wide-bandwidth filter. In some systems, such as a headphone environment, ear pads can have diameters exceeding 7.5 cm, and quarter-wave effects thus down to approximately 1.8 cm. With proper design of the top surface 204 and assorted channels 202/206, a diverse range of resonator wavelengths can be targeted, which enables insert 190 deployment with to resolve a broad range of potentially problematic standing waves within a headphone environment.

FIGS. 7A-7D respectively depict portions of an example insert 210 arranged in accordance with various embodiments to tune and optimize the transmission of acoustic waves to a user's ear drum. As conveyed in FIG. 7A, a non-limiting example of a single piece of rigid material has a pattern 212 of channels that are each configured with a hexagonal shape in the X-Y plane. It is noted that the respective channels extend from an aperture that has a tuned shape and can be utilized in the pattern 212 alone, or in combination. For instance, all, or some, apertures may be configured with circular, triangular, rhomboid, or parallelogram shapes, of matching, or varying cross-sectional sizes, in the X-Y plane to provide a desired waveguide and resonator behavior in use.

The ability to arrange the respective channels of the pattern 212 with different, varying, or uniform sizes, shapes, and orientations relative to the Z axis allows for a diverse variety of waveguide, diffusion, and resonator characteristics that control frequency response and standing waves. Further tuning of the respective channels associated with the pattern 212 can be facilitated by configuring the cross-sectional area of the insert 210 along the Z-X plane, as illustrated in FIG. 7B. By configuring some channels 214 as open and extending through the thickness (T) of the insert 210 while other channels 216 are terminated, which can be defined as having a depth to the blocking surface 218 that is less that the complete insert thickness. It is noted that while the blocking surface in FIG. 7B has a uniform thickness along its length, along the X axis, such configuration is not required and the blocking surface 218 can define a variety of different, perhaps varying, depths for one or more closed channels 216 and the blocking surface 218 may also have a small tuned aperture that matches, or differs, from other insert aperture shapes, sizes, and orientations.

Through the channels 214/216 tuning, the propensity to develop standing waves is reduced by placing a structure comprised of diffusion surfaces 220, embedded audio waveguides 214, and absorption structures 216 between the audio transducer and the user's ear. It is contemplated that the various aspects of the insert 210 may be integrated into, or under, an ear pad fabricated of, for instance, fabric, foam, 3D printed polymer, or molded materials.

It is contemplated that the open channels 214 form audio waveguides that can be configured with any cross-sectional geometry, may be straight or tapered, and may be vertical or angled relative to the audio transducer to customize the acoustic energy transmission through the insert 210. The open channel 214 waveguides may be of uniformly, or variably, spaced and sized within the pattern 212. Some embodiments arrange the closed channels 216 as quarter wave resonators, as shown, while other embodiments provide Helmholtz resonators with the closed channels 216. The respective resonators may have varied cross-sectional shapes, and may and may even be “folded” around themselves, follow a swept, or follow irregular path along the Z axis to provide longer acoustic energy path lengths and control lower frequencies, such as below 3000 Hz.

FIG. 7C conveys a front plan view of the ear-side of the insert 210 while FIG. 7D illustrates a side view of the insert 210. FIG. 7D depicts how some apertures 214/216 can be angled with respect to the Z axis, such as, but not limited to 5-45°. The combination of the varying insert thickness, as provided by the contoured top surface 224, and tuned aperture 214/216 characteristics allows frequency transition to be smoothed, standing waves to be mitigated, and resonance to be optimized to the structure of a user's ear.

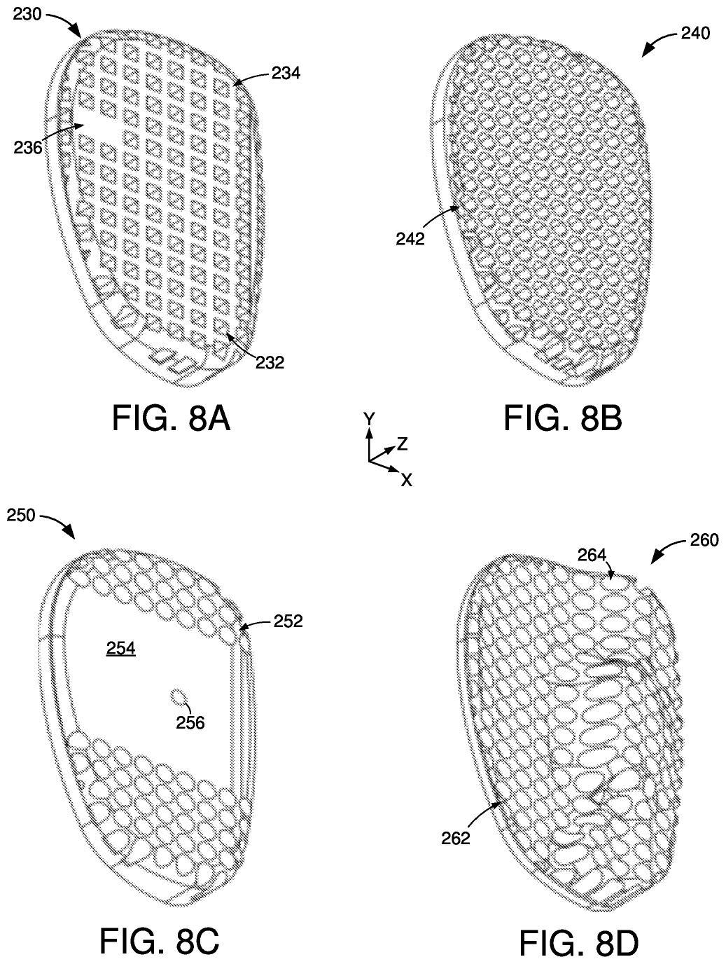

In FIGS. 8A and 8B, line representations convey assorted embodiments of an example insert. Insert 230 of FIG. 8A depicts a perspective view of an example insert 230 configuration where square channel 232 cross-sectional shapes along the X-Y plane are arranged in a uniform pattern 234, and associated channels that extend into the thickness of the insert, are employed in combination with a continuous surface region 236 that is void of apertures 232, which presents a larger area to diffuse energy, or which may contain additional filters underneath the solid surface, such as a longer quarter wave resonator or Hemholtz resonator. The uniform pattern 242 of hexagonal-shaped channels in FIG. 8B illustrate how the insert 240 can have partial and complete channel cross-sections.

The example insert 250 of FIG. 8C illustrates how a uniform pattern 252 of separate channels can be bifurcated by a continuous surface 254 that tunes how acoustic energy reacts to the insert 250. It is contemplated, but not required, that the continuous surface 254 can have a port 256 that may match, or be dissimilar from, the other channels extending into the thickness of the insert 250.

While the top surfaces of the inserts shown in FIGS. 8A, 8B, and 8C have a relatively smooth gradation of the surface, it is contemplated that relatively drastic undulations in top surface topography can be utilized.as shown in FIG. 8D. It is further contemplated that the top surface can be partially, or completely, coated with a porous-matrix.

Insert 260 of FIG. 8D illustrates such drastic undulations as the top surface 262 provides a number of localized protrusions, dips, and slopes that each vary the thickness of the insert 260 along the Z axis along with the length of the separate channels 264. It is noted that the relatively drastic top surface 262 topography may, or may not, alter the cross-sectional shape of some channels 264, in the X-Y plane.

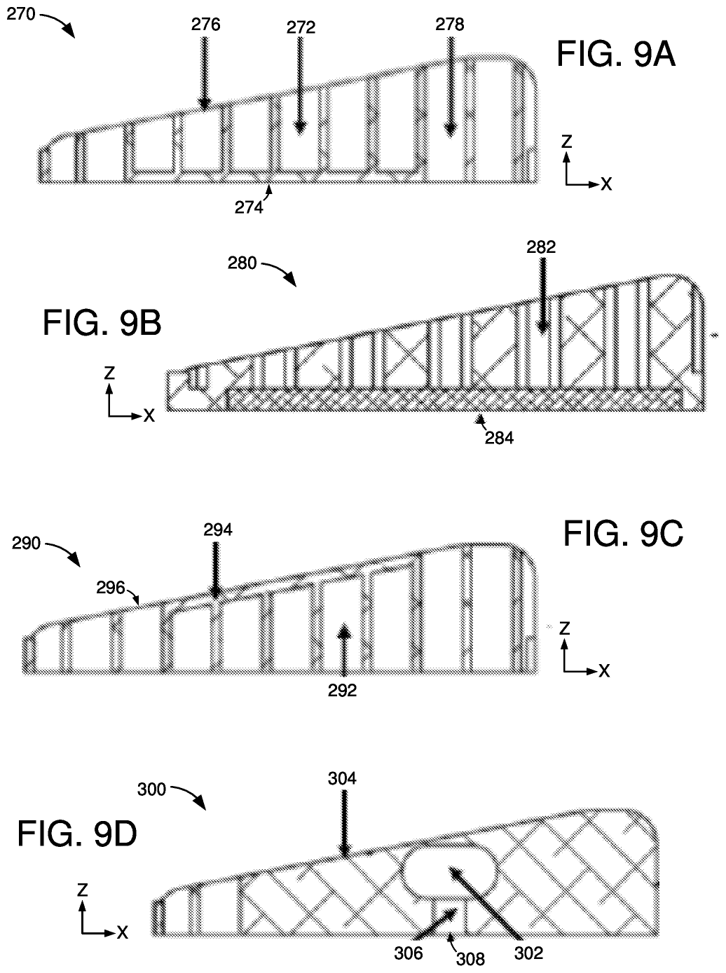

FIGS. 9A-9D respectively depict cross-sectional line representations of example inserts configured in accordance with various embodiments to be capable of optimizing acoustic energy transfer from a headphone audio transducer to a user's ear. Insert 270 of FIG. 9A shows an embodiment where closed channels 272 are configured as quarter-wave resonators by being terminated on the bottom, transducer side 274 of the insert 270. A continually sloped ear-side, top surface 276 may be flat, contoured, or tapered to define a different depth for each channel resonator so that respective resonators have varying depth, as shown by insert 280 of FIG. 9B. The combination of different closed channels 282 with varying depth can complement an acoustic material 284 to manipulate larger parts of the acoustic spectrum as an array, while multiple aperture resonators of the same length may be combined to increase the depth of the resultant acoustic energy notch-filter.

It is noted there is no requirement for the closed channel 272/282 resonators to be vertically oriented or aligned in any way with the acoustic wave guides, and the waveguides may be curved or folded to increase their length to address lower frequencies. Further, a system design may incorporate any desired combination of quarter wave and Helmholtz closed channel 272/282 resonators to achieve desired acoustic energy manipulation, control, and transfer.

As displayed in FIG. 9C, an insert 290 can terminate closed channels 292 with a blocking surface 294 positioned on an ear-side, top surface 296 to create an acoustic wave resonator. Such closed channel 292 inversion, compared to the apertures/resonators of insert 270, positions resonating acoustic energy proximal to the ear and away from the audio driver, which allows for the creation of large surfaces proximal to the ear which can either be coated with porous damping material or left as rigid material hard to be reflective as appropriate to the application. Also, it is noted that by placing the blocking surface 294 on the ear-side of an insert, a notch-filter may be deployed prior to an acoustic wave entering the air volume, which results in a stronger filter effect at the acoustic wave source, particularly if impedance node 106 is present.

While not required or limiting, an insert 300 can be configured with a Helmholtz resonator. FIG. 9D conveys how a Helmholtz resonator 302 can be embedded underneath a diffusion/reflection surface 304. As with a quarter-wave closed channel resonator, the Helmholtz resonator 302 may be terminated proximal to the driver or proximal to the ear. It is contemplated that a single Helmholtz resonator 302 is utilized in an insert that is otherwise solid and rigid, but some embodiments configure a plurality of resonators 302 separated throughout the insert 300. A Helmholtz resonator 302 can consist of an channel 306 that can extend to the ear-side top surface 304 or to the driver-side bottom surface 308, as shown.

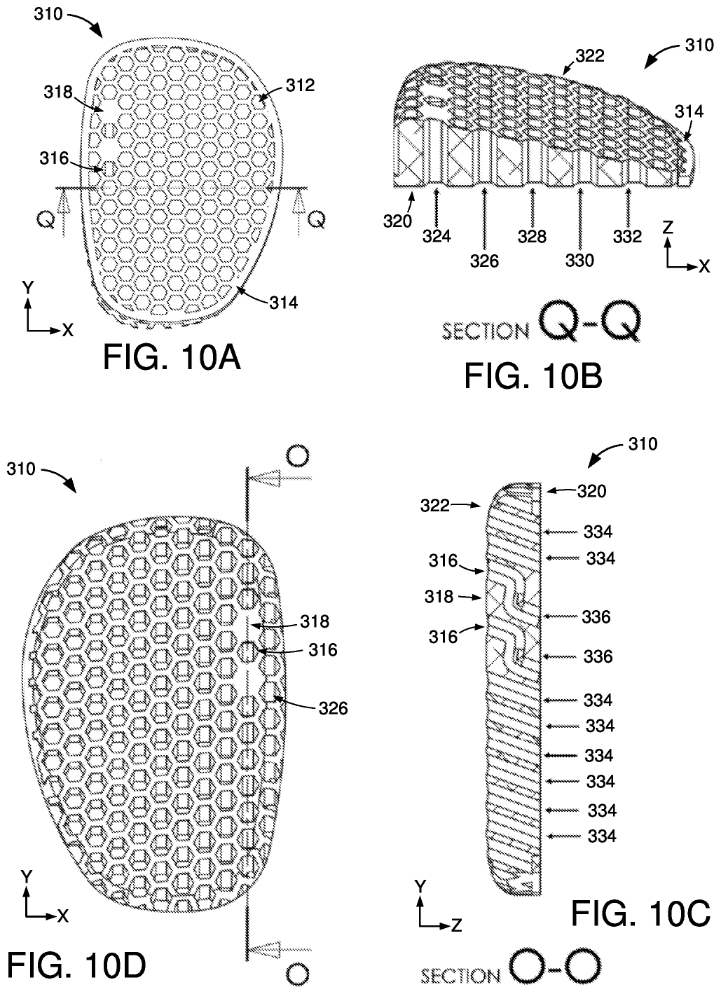

The ability to route insert channels in a variety of different lengths and orientations allows for diverse frequency tuning. FIGS. 10A-10D respectively depict portions of an example insert 310 that can be utilized in a headphone in accordance with various embodiments. The insert 310 has a plurality of separated channels 312 that are arranged in a pattern within a continuous perimeter 314 and each extend through the entire thickness of a single piece of rigid material, along the Z axis. It is contemplated that one or more channels 312 are closed and do not extend through the entire thickness so as to create a resonator, but such arrangement is not shown, limiting, or required.

The driver-side view of FIG. 10A illustrates how two channels 316 correspond with a solid void 318 and are each defined by an acoustic tube that travels laterally along the X-Y plane, which can be characterized as a swept path channel. The cross-sectional view of FIG. 10B illustrates how the driver-side 320 of the insert 310 is flat and parallel to the X-Y plane while the ear-side 322 of the insert 310 is contoured with multiple different surface orientations. The varying contour of the ear-side 320 results in different channels 312 resulting in different lengths, as measured along the path length (Z axis), as shown with the Q-Q section of FIG. 10B.

In the non-limiting insert 310 configuration, channel 324 is approximately 9 mm long with the thickness of the insert 310 being 10 mm and corresponding to a half-wave resonator operating at approximately 9.6 KHz. Meanwhile, channel 326 can be arranged with approximately a 10 mm depth along the Z axis, which corresponds to approximately 8.6 KHz operating frequency while channel 328 has approximately an 8 mm depth that corresponds to 10.7 KHz operating frequency, channel 330 has approximately a 6 depth corresponding to 14.2 KHz operating frequency, and channel 332 has approximately a 4 mm depth that corresponds to 21 KHz operating frequency. Finally, folded channel 316 can have a length of 15 mm that corresponds to a resonator frequency of 5.5 KHz.

It is contemplated that channels 312 with different configurations, such as length along the Z axis (depth), cross-sectional area along the X-Y plane, total volume of an channel 312, and/or orientation of the channel 312 relative to the Z axis, provide a wide array of frequency range operating frequencies for quarter wave resonators that result in smoother acoustic transitions between frequencies than if a single operating frequency was utilized. It is noted that the combination of channel 312 customization can be complemented by ear-side surface geometry to create waveguides and/or resonators specific to frequencies of interest.

With the configuration of the ear-side topography 322, the lower frequency limit of the insert 310 is not limited by the thickness of the insert 310 itself or channel 312. Lower frequency resonators may be created, in some embodiments, by making the insert 310 thicker so as to increase the depth/length of some channels 312, or by creating a waveguide or resonator path of the desired length that is longer than the thickness of the insert by curving, folding, or otherwise embedding, the longer resonator within the insert 310 to increase the effective resonator length, as shown in channels 336 the O-O cross-sectional view of FIG. 10C.

It is important to consider the potential of the channel 312 configurations as a resonator array able to create both highly targeted and broad-based frequency corrections within the range defined by the waveguides (open channels 312/336). As illustrated in the non-limiting cross-section O-O of FIG. 10C, an array of identical open channels 334 are each angled with respect to the Z axis and have a uniform cross-sectional shape/area from the driver-side 320 to the ear-side 322, which provides a greater length than would be available if the channels 312 were parallel to the Z axis.

Any number of folding channels 336 can further extend the operative length of an open channel to form longer path lengths supporting lower frequency resonators, while adding parallel resonators increases the attenuation of the array, and changing hard termination to impedance nodes and porous-matrix material lower filter Q and attenuation. The plan view of the ear-side 322 of the insert 310 in FIG. 10D conveys how the folded apertures 336 produce the same solid voids 318 as the driver-side 320 as a result of the lateral travel of the aperture tube.

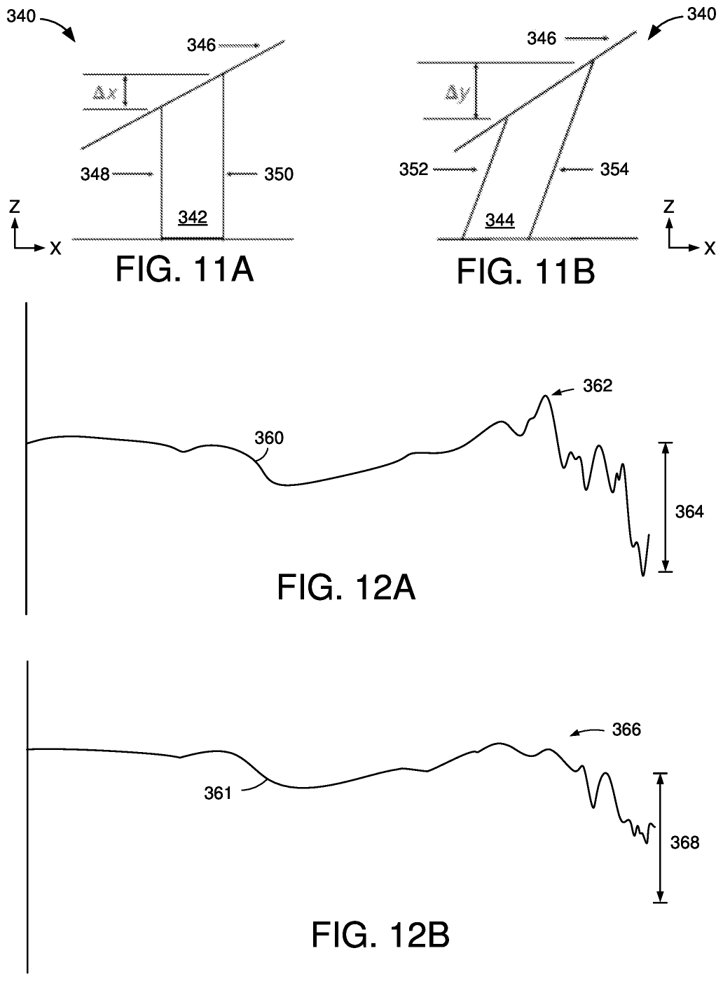

FIGS. 11A and 11B respectively convey portions of an example insert 340 that can be constructed and operated in accordance with assorted embodiments. It is noted that the configuration of a channel with sidewalls parallel to the Z axis, as shown by the aperture 342 of FIG. 11A, or with sidewalls angled relative to the Z axis, as shown by aperture 344 of FIG. 11B, controls the Q factor. In quarter-wave resonator designs where a channel does not extend completely through the thickness of the insert 340, it is possible to adjust the Q by varying the depth of the sidewalls that define the resonator. The larger the differential in the sidewall depth, the lower the Q and the shallower the resulting filter.

The example channel 342 of FIG. 11A shows how the slope of the top surface 346 creates Δx by shortening one resonator sidewall 348 relative to the opposite sidewall 350. The example aperture 344 of FIG. 11B shows that by angling the resonator relative the top surface 346, Δy is formed by the difference in resonator sidewall heights 352 and 354. It is noted that if the sidewall height 348 is equal to sidewall height 350 and the slope of the top surface 346 is less for aperture 342 than for aperture 344, which equates to Δx being less than Δy, Δy has a lower Q factor.

As shown in FIG. 10C, the non-limiting embodiment of multiple resonators 334 of a given depth may be deployed to increase attenuation at the target operating frequency. To select a broader array of frequencies, a horizontal selection of channels, as shown in FIG. 10B, shows a pattern of decreasing depth along the horizontal axis (X axis), and when terminated may form resonators of increasing frequencies until they reach ultrasonic wavelengths. This creates a novel design whereby the insert designer can deploy multiple identical filters to increase attenuation at the target frequency as well as a wide array of target frequencies, while precisely tuning filter Q and attenuation to create notch, or overlapping, broadband filters.

As a result of the tuned configuration of the assorted apertures of a single-piece insert, acoustic energy absorption and diffusion are combined to provide custom acoustic wave transmission as a generic aspect of an insert optimized for a particular user's ear. It is noted that an insert does not, necessarily, fill an entirety of a headphone ear cup or wholly cover the transducer, although driver coverage of at least 50% ensures more effective system operation. Incomplete coverage of the transducer, or baffle around the transducer, can produce empty, non-filled space or space for secondary waveguides/resonators or simple acoustic foams or felts.

Operational data 360 of FIG. 12A shows a planar magnetic audio transducer headphone measured on a GRAS 45CA without an insert with tuned apertures where the audio transducer is generating an audio pressure wave that passes through a compression chamber and impedance node. It can be seen that there is a pronounced peak 362 at approximately 5.8 KHz. Above 10 KHz, the frequency response is very irregular, which is characteristic of complex standing waves, as illustrated by range 364.

Through the addition of an insert tuned in accordance with assorted embodiments, frequency response is optimized, as conveyed by operational data 361 of FIG. 12B. It is noted that the exact same headphone is used for data 360 and 361 with the same GRAS 45CA audio equipment. Data 361, however, corresponds with an impedance node and porous-matrix material positioned proximal to a tuned insert consisting of at least one folded closed aperture to target the 5.8 Khz peak 362 of FIG. 12A. It is noted that two folded 5.8 KHz resonators can pull 5 dB out of the operational frequency curve, as shown by region 366, which displays a smooth, continuous response in the region of interest with a complete absence of the standing wave clearly present in peak 352.

It can further be seen that the wild amplitude swings in range 364 are considerably smoothed in range 368 through the use of the tuned insert. That is, the tuned array of resonators terminate with hard blocking surfaces address 5.5 and 8-10 KHz. Meanwhile, multiple shorter apertures of varying length are terminated with an impedance node and porous-matrix material layers to create overlapping low Q filters that smooth frequency response above 10 KHz. Finally, a degree of diffusion is created by wave diffraction off an ear-side top surface of the insert with contours and closed/open space ratios being used to modify the effect, which can be customized to be user and application specific.

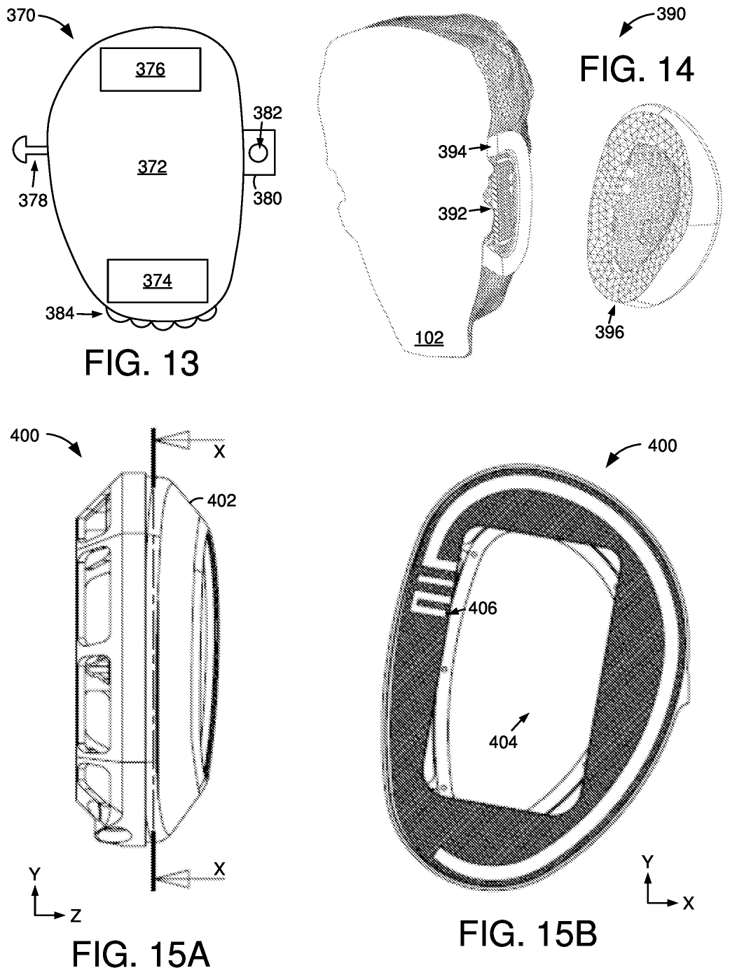

FIG. 13 depicts portions of an example insert 370 that can be utilized to condition acoustic waves in accordance with various embodiments. The insert 370 has a rigid body 372 that can support one or more attachment features. While not required or limiting, an adhesive 374 may be applied to the insert body 372 to allow for selective incorporation into a headphone ear cup or ear pad. Some embodiments provide an adhesive in the form of a sticker 376, which may be employed alone or in combination with other physical attachments to a headphone ear cup or ear pad.

One or more attachment features may extend from the insert body 372 to facilitate connection between an audio driver and a user's ear drum. For instance, a keyed protrusion 378 may engage a keyed aperture in a headphone to allow the insert body 372 to be securely retained. A flexible, or rigid, tab 380 may extend from the insert body 372 and present one or more fasteners 382, such as a button, screw, pin, or tie. It is contemplated that any number of different attachment features can be utilized to physically secure the insert body 372 onto, or inside, a headphone ear cup or ear pad.

FIG. 14 depicts a partial cross-sectional view of portions of an example headphone system 390 that employs an acoustic wave conditioning insert 392 positioned inside an ear pad 394 proximal the ear of a user 102. It is understood that layers 196/198, the transducer, and the remainder of the headphone coupler are not shown in FIG. 14 for the sake of clarity. In the majority of cases, the insert assembly will be attached directly to the transducer and/or baffle assembly holding the transducer, but in accordance with some embodiments, the insert 392 can be incorporated into, or attached to, the ear pad, as illustrated by pad 396. Regardless of how the insert 392 is connected headphone coupler, the positioning of the insert 392 between an audio transducer and the user's ear allows the tuned waveguides, resonators, and diffusion structures of the insert 392 to optimize the transfer of acoustic waves to the user 102.

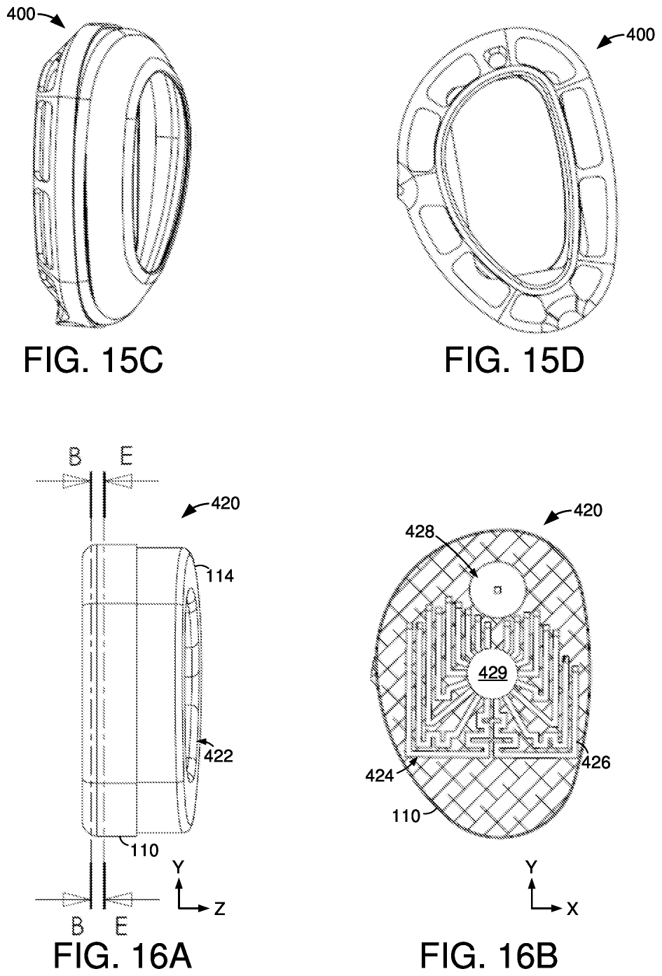

FIGS. 15A-15D respectively depict portions of an example ear pad 400 that can be employed in a headphone in accordance with various embodiments to provide acoustic waveguide, diffusion, and absorption. The side view of FIG. 15A conveys how the ear pad 400 can have a unitary body 402 that may be constructed of one or more materials to surround the ear of a user. It is contemplated that the ear pad is fabricated as a single piece via 3D printing or molding. The ear pad can be created as a waveguide embedded within the foam core of an ear pad. Such methods allow one or more channels, such as an open waveguide, closed resonator, or tuned length sound tube, to be incorporated into the ear pad 400 without attachment of a separate insert to support lower frequency attenuators than may be directly integrated into the acoustic metamaterial tuning system.

The cross-sectional view from plane X-X in FIG. 15B illustrates the ear-facing side of the ear pad 400. The ear pad 400 has a centrally located ear aperture 404 that is surrounded by an ear structure 406 where one or more acoustic tuning features can be positioned. The ability to incorporate acoustic waveguide and/or resonator channels into the ear pad 400 allows for optimal user comfort and acoustic performance that can be changed by switching between different ear pads 400 along with the ability to use very long resonators to address frequencies down to 50 Hz. That is, embodiments configure the ear pad 400 to be interchangeable to different ear couplers and/or headphones, which allows different acoustic features to be installed with the attachment of an ear pad 400 to an ear coupler of a headphone.

FIGS. 15C and 15D respectively depict how a resonator can be incorporated into an ear pad 400. It is contemplated that any waveguide, resonator, impedance node, and/or porous-matrix acoustic tuning can be attached or built-in the ear pad. Some embodiments of an ear pad 400 allows acoustic tuning aspects to be interchangeable without removing the ear pad 400 from a headphone. Other embodiments allow acoustic waveguide, resonators, impedance nodes, and/or porous-matrix aspects to be attached, or removed to a headphone system through the interchanging of an entire ear pad 400 from an ear cup, as generally conveyed in FIG. 1.

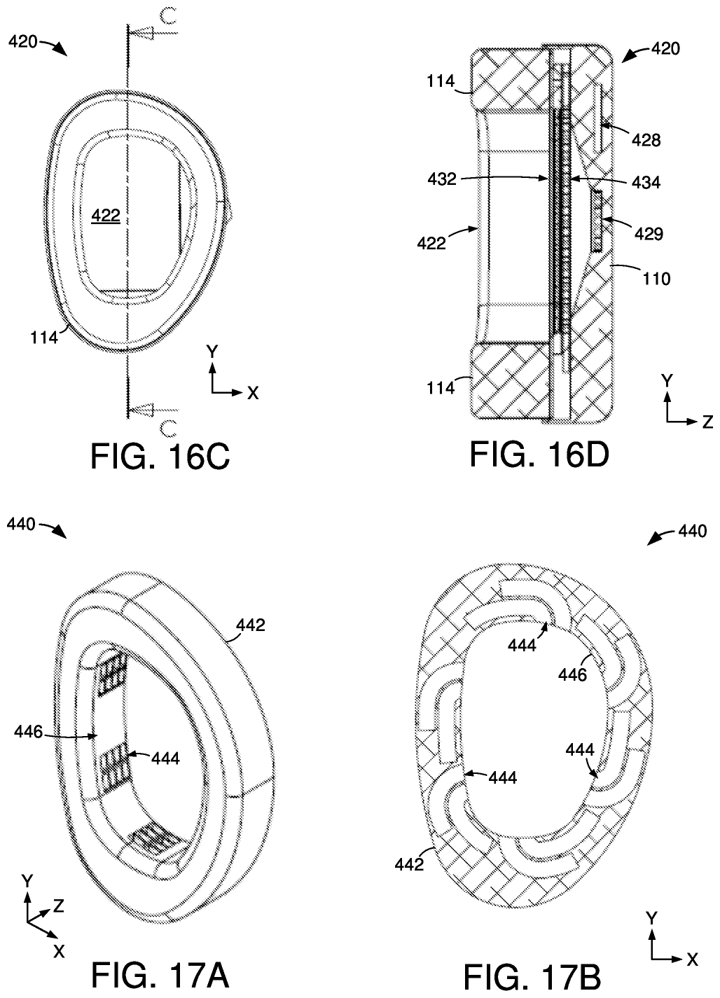

FIGS. 16A-16E respectively depict aspects of an example headphone 420 that is configured in accordance with various embodiments. In the side view of FIG. 16A, an ear coupler 110 is attached to an ear pad 114 that surrounds an ear recess 422 with a closed, or semi-closed, configuration that creates a volume of air behind the driver 434. It is contemplated that the ear coupler 110 houses one or more acoustic drivers and is maintained in position on a user's head by at least one headband, as shown in FIG. 1. As compared to closed ear cups, housings, or bodies, embodiments of the ear coupler 110 with a closed, or semi-closed, configuration that provides integrated resonators 424 where separate channels 426 that are positioned behind the driver 434 act as quarter wave resonators and/or Helmholtz resonators to absorb acoustic energy that is otherwise stored within the volume enclosed by the coupler 110, as shown in FIG. 16B.

The B-B cross-section of FIG. 16B further conveys how the respective channels 426 are combined in a pattern of different tuned channel lengths to provide absorption across a frequency range and/or for a specified frequency for passing sound waves. Also integrated into the ear coupler 110, or otherwise placed within the volume defined by the rear cup portion of the coupler 110, as illustrated in FIG. 16B, is a Helmholtz resonator 428 with an aperture 429 allowing air to enter the volume defined by the rear cup portion of the ear coupler 110 for targeted absorption of acoustic energy.

While not limiting or required, the ear coupler 110 can be printed, molded, or otherwise formed as a unitary body, or multi-part assembly, with one or more channels 426 continuously extend within the coupler 110 to any number of ports 429 located on the interior side of the coupler 110, facing the driver/transducer of the headphone 420, as shown in FIG. 16B, which is along the B-B cross-section of FIG. 16A. The array of waveguides 424 comprise multiple lengths and cross-sectional areas to address absorption of a broad spectrum of acoustic frequencies, as previously described. It is noted that the respective ports 429 can be configured with unique, or uniform, sizes and shapes that provide a designer an ability to tune how airflow enters the ear recess 422 for use by one or more acoustic drivers/transducers.

FIG. 16C depicts an ear-side profile of the headphone 420 and illustrates how the ear pad 114 can continuously surround and define the ear recess 422. Various embodiments of the headphone 420 configure the coupler 110 with one or more channels configured as quarter wave, or Helmholtz, resonators to tune the acoustic frequency response and presence of standing waves within the volume of air between the transducer and coupler 110. Along cross-section C-C, FIG. 16D depicts a non-limiting example of how a metamaterial insert 432 can be positioned within the volume of air between an acoustic driver 434, such as a planar magnetic or electrostatic transducer, and the rear wall of the ear coupler 110. FIG.16D further illustrates how the driver 434 placement within the ear coupler 110 provides open space and distance between the ports 429 to the resonators 426/428, which can varied and tuned to optimize driver 434 operation, frequency range, and frequency response.

In some embodiments, the waveguide channels 426 are characterized as resonators, which can be positioned parallel to the driver 434 while other embodiments orient the channels/resonators 426 vertically, or at arbitrary angles, with respect to the driver 434. In other words, placement of channels/resonators 426 is non-limiting and may be proximal to the driver 434, as shown, where ports 429 are within the areal extent of the driver 434 or where channels/resonators 426/428 can be perpendicular, or otherwise oriented, relative to the driver 434.

It is contemplated that the channels/resonators 426/428 directly couple to the driver 434 or are separated from the driver 434 by an air gap, as shown, with optional use of poro-acoustic materials placed within the volume. The ability to tune the position of the driver 434, configuration of the damping insert 432, and configuration of the channels/resonators 426 allows for sophisticated acoustic control that is customized to the ear topography of a user to provide optimized frequency response, range, and amplitude.

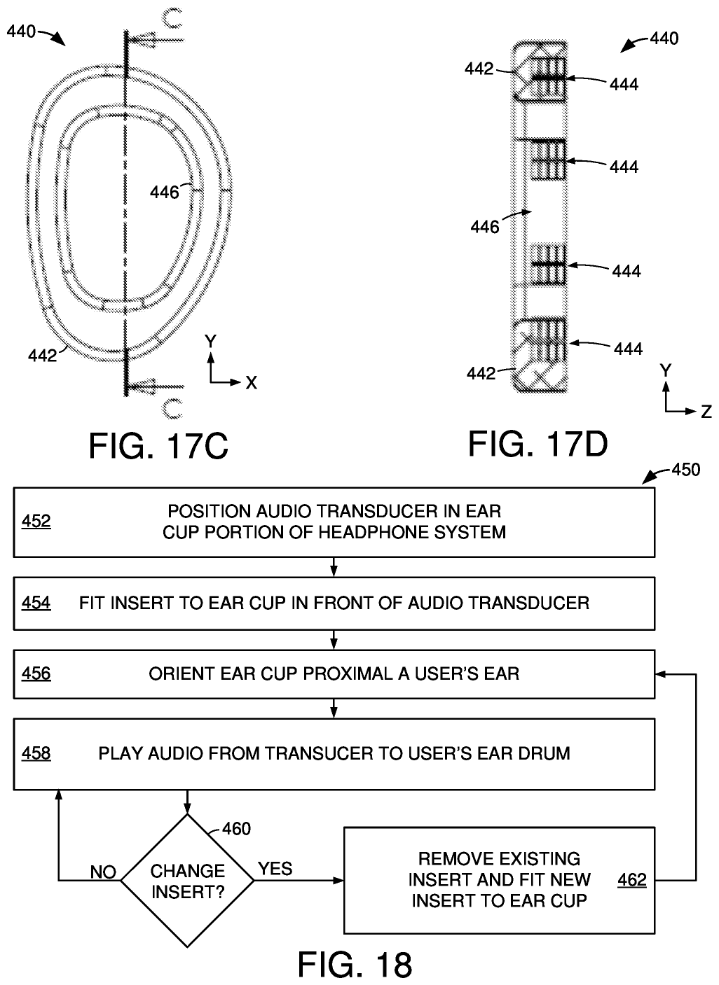

FIGS. 17A-17D respectively depict portions of an example ear pad 440 that can be employed as part of a headphone in various embodiments to provide enhanced acoustic performance. By printing, or otherwise fabricating, an ear pad 440 as a unitary structure or multi-part assembly, relatively intricate metamaterial structures can be incorporated into the pad body 442. The perspective view of FIG. 17A conveys how the pad body 442 can be configured with a shape and size that is conducive to surrounding the ear of a user. It is contemplated that the pad body 442 is arranged to fit atop a user's ear with apertures placed around the interior surfaces of the cavity ______### defined by the inner wall of the ear pad 440, the ear, as well as the coupler and driver.

The ear pad assembly 440 provides acoustic wave manipulating channels 444 along an inner body surface 446, which positions each aperture 444 into the cavity defined by the user's ear and the acoustic wave source(s) of an ear coupler and driver assembly that is attached to the pad 440. It is noted that the respective channels 444 of the ear pad 440 are separate and respectively tuned as quarter wave, or Helmholtz, resonators to mitigate the degradation of acoustic properties.

Unlike the inline resonators that are also waveguides, channels 444 are purely for implementation as various resonators. The cross-sectional view of FIG. 17B illustrates how, when configured as quarter wave resonators, the respective channels 444 are hollow and terminate at a predetermined length from the inner body surface 446. The tuning of the size, length, and position of the various channels 444 allow a designer to provide unique, or redundant, structures to control how air and acoustic energy are transferred from source to a user's ear drum.

The plan view of FIG. 17C shows cross-sectional line C-C from which the cross-sectional view of FIG. 17D is taken. The view of FIG. 17D conveys how multiple channels 444 can be grouped in close proximity, which forms a three dimensional matrix, on the inner body surface 446 without connecting to each other. Yet, some embodiments configure one or more pad channels 444 to extend from multiple inner surface 446 ports. Hence, a channel 444 can further be customized for how it engages the exterior surface, or interior volume of the pad assembly 440.

The flowchart of FIG. 18 depicts an example acoustic insert utilization routine 450 that can be carried out with the assorted embodiments of FIGS. 1-17F. Initially, a headphone system is provided in step 452 with at least one audio transducer positioned in an ear cup. One or more acoustic inserts are attached to the ear cup, or an ear pad portion of an ear cup, in step 454 so that the insert(s) condition acoustic waves prior to being received by a user.

The physical positioning of an ear cup and acoustic insert proximal a user's ear in step 456 allows for optimized acoustic wave conditioning in step 458 as the audio transducer generates sound that passes through the insert before being received by the user's ear drum. It is contemplated that step 458 can occur for any amount of time while decision 460 evaluates if a different acoustic insert is in order. If no insert can improve the conditioning of acoustic waves or change the acoustic characteristics to a user's desire, routine 450 returns to step 458. However, if a different insert is called for, step 462 proceeds to remove the existing insert and fit a new insert to the ear cup before returning to step 456.

In accordance with some embodiments, a volume of material is placed between the audio transducer of an over-ear headphone and the listener's ear to create a system to control high frequency standing waves. The system is comprised of one or more of the following elements; audio diffusion, acoustic metamaterial, waveguides, and acoustic resonators. Diffusion is created either by reflection off the surface of the material or passing the audio wave through a diffusion matrix material such as a non-limiting example of foam or gyroid. A perforated surface between the transducer and ear reflects a portion of the reflected wave energy back to the ear while the balance re-enters the waveguide and/or resonator channels. A complex structure like a gyroid provides very high levels of diffusion without much surface area. The two approaches may be combined or used separately to manage diffusion.

The diffusor surface may be sculpted to move the diffusion surface closer to the ear to shift standing waves to higher frequencies, possibly in the ultrasonic frequencies. This may be shaped to conform to an average ear to minimize the gap between the insert and the ear. A 3D scan of an ear may be used to customize the diffusor surface to be specific to an individual. The surface of the structure may be regular with a steady sloped or domed geometry, or irregular and contoured to more closely mirror the geometry of an average ear.

Waveguides are terminated at either end by perforations in the structure. The perforations may be identical on both ends, or vary in size and shape. The channel between the terminations may be uniform in area, or modulated in area to serve as a waveguide. The channel may be straight, folded, or curved. The channels may be terminated to create a quarter wave or as a Helmholtz resonator embedded directly into the structure, allowing targeted filtration of specific standing waves which diffusion alone can't control. By embedding a plurality of resonators into a diffusion structure it is possible to provide both broad and fine-tuned control of resonances at one or more frequencies and of variable Q.

It is possible to incorporate the physical structure of the resonator into the diffusion pattern of the assembly, either by terminating airflow structures within the assembly or creating structures of varied shape underneath the diffusor surface. The diameter of the audio transmission tubes may be varied to adjust the acoustic impedance seen by the driver to control damping. Using complex tube geometries, tubes can be folded/extended to arbitrarily longer lengths so that when terminated to function as quarter wave or Helmholtz resonators they enable filtration of lower frequencies than could be supported strictly by using straight tubes. A 3D printed or conventional ear pad with the diffusion/absorption system built in is also possible.

Embedding resonators in the ear pad itself allows for potentially significantly longer resonators to address lower frequency resonances than could be handled in the more limited volume between transducer and ear. A multiplicity of terminated tubes of different lengths can be used to create a metamaterial damping system that controls the frequency response of a broad region of the audio spectrum, or to fine-tune multiple regions of the spectrum to achieve a desired result. Variable tube length is inherently possible in any structure of adequate volume to support the appropriate channel for a quarter wave resonator or volume for a Helmholz resonator. The diffusion and absorption system may be attached to the driver, driver baffle, or directly integrated into an ear pad constructed using conventional or 3D printing methods. Orientation and geometry of tubes can be altered to form wave guides to direct energy to specific parts of the ear structure and/or alter frequency response or to create special effects.

Utilization of impedance nodes and porous-matrix materials between the transducer and the tuning system or between the tuning system and the ear can substantially improve system performance by turning waveguides into dual-function devices that are both waveguides and resonators. This gives the system designer unparalleled flexibility to balance waveguides and resonators for precision tuning. The contour of the diffusion surface may be sloped and the angle of the resonators relative to the surface modify the Q of quarter-wave resonators embedded within the structure. The slope and angle work together to decrease the height of one side of the resonator relative to the other, which lowers the Q of the resonator of the system, resulting in a lesser amplitude affect across a broader range of frequencies. A 3D lattice and/or gyroid may be incorporated into the design to create an alternate method of diffusion beyond surface reflections noted above.

What is claimed is:

1. A headphone comprising:
an ear coupler comprising a transducer and ear pad, the ear pad defining a volume surrounding an ear of a user; and
an insert positioned inline between the transducer and the ear of the user to fill at least a portion of the volume defined by the ear pad, the insert having a thickness and a plurality of channels, a first channel of the plurality of channels continuously extending through the insert to form a waveguide, a second channel of the plurality of channels having a length that is less than the thickness of the insert to form a resonator.

2. The headphone of claim 1, wherein the insert is a single piece of material.

3. The headphone of claim 2, wherein the single piece of material is polymer.

4. The headphone of claim 2, wherein the single piece of material comprises a gyroid structure.

5. The headphone of claim 1, wherein the resonator is a quarter wave resonator or a Helmoltz resonator.

6. The headphone of claim 1, wherein the insert is embedded in an ear pad connected to the ear cup.

7. The headphone of claim 1, wherein a first channel of the plurality of channels has a different cross-sectional shape than a second channel of the plurality of channels.

8. The headphone of claim 1, wherein a first channel of the plurality of channels has a varying cross-sectional shape through a thickness of the insert and a second channel of the plurality of channels has a uniform cross-sectional area throughout the thickness of the insert.

9. The headphone of claim 1, wherein a topography of a top surface of the insert is customized to a geometry of the user's ear.

10. The headphone of claim 1, wherein a topography of a top surface of the insert creates an impedance node to diffuse standing waves.

11. The headphone of claim 1, wherein a first channel of the plurality of channels has a length greater than a thickness of the insert, as measured perpendicular to an ear side surface of the insert.

12. The headphone of claim 1, wherein a filter is attached to the insert, the filter comprising a porous-matrix material to lower a Q value for acoustic waves passing from the acoustic transducer and the ear of the user.

13. The apparatus of claim 10, wherein the insert has a ratio of surface area to a number of channels of the plurality of channels, the ratio selected to provide a predetermined amount of transducer damping during operation.

14. An apparatus comprising:
an ear coupler housing a transducer and connected to an ear pad; and
an array of channels controlling operation of the transducer by forming at least one resonator

15. The apparatus of claim 14, wherein the array of channels forms at least one waveguide concurrently with the at least one resonator.

16. The apparatus of claim 14, wherein the array of channels is integrated into the ear coupler.

17. The apparatus of claim 14, wherein the array of channels is integrated into the ear pad.

18. A method comprising:
positioning a first insert in a coupler and inline between a transducer and an ear of a user, the insert comprising a first plurality of channels arranged to reduce an amplitude of standing waves of acoustic signals created by the transducer;
generating acoustic signals with the transducer, the acoustic signals passing through the first insert, the first insert having an acoustic impedance provided by the plurality of channels to create a predetermined acoustic damping;
removing the first insert from the ear coupler;
attaching a second insert into the ear coupler, the second insert having a second plurality of channels arranged to provide a different frequency response than the first plurality of channels.

19. The method of claim 18, wherein the first insert and the second insert each diffuse acoustic signals, absorb acoustic signals, and provide a waveguide for acoustic signals from the transducer to the ear of the user.

20. The method of claim 18, wherein a first top surface of the first insert is different than a second top surface of the second insert, the first top surface configured to mirror a contour of the ear of the user in response to the ear of the user being scanned.
